(19) United States
(12) Patent Application Publication
(10) Pub. No.: US 2014/0372200 A1
(43) Pub. Date: Dec. 18, 2014

(54) Offer Privacy Controls

(71) Applicant: Target Brands, Inc., Minneapolis, MN (US)

(72) Inventors: Audrey Josephine Leicher, Minnetonka, MN (US); William John Bitunjac, New Brighton, MN (US); Natalie Victoria Doyne, Minneapolis, MN (US); Sarah Roxanne Peterson, St. Paul, MN (US)

(73) Assignee: Target Brands, Inc., Minneapolis, MN (US)

(21) Appl. No.: 13/916,116

(22) Filed: Jun. 12, 2013

(51) Int. Cl. G06Q 50/00; G06Q 30/02

(52) U.S. Cl. CPC G06Q 50/01; G06Q 30/0257
USPC 705/14.39; 705/14.55

(57) ABSTRACT

A user interface that requests offer information for an offer provided by a vendor is provided to the vendor's computing device. The offer information is received from the vendor's computing device where the offer information includes a vendor privacy setting that indicates whether the offer is private. A request is received from a consumer's computing device for available offers and a user interface containing the offer is provided to the consumer's computing device. An indication that the consumer selected the offer is received and the offer and the vendor privacy setting are stored.

### BACKGROUND

Retailers publish discounts and sales offers on the Internet. A consumer can select an offer and use it during an electronic transaction or print the offer and redeem it during a transaction at a physical store.

“Social media” includes a collection of Internet and/or cellular network technologies that allow people to share information about their lives. In many of these technologies, a list of friends or followers is associated with a particular user such that when the user updates information about their lives, their friends or followers are notified. In some social media settings, when a user takes an action on an Internet page, that action is automatically updated on the user's social media postings so that their friends and followers are made aware of the user's actions.

The discussion above is merely provided for general background information and is not intended to be used as an aid in determining the scope of the claimed subject matter. The claimed subject matter is not limited to implementations that solve any or all disadvantages noted in the background.

### SUMMARY

A user interface that requests offer information for an offer provided by a vendor is provided to the vendor's computing device. The offer information is received from the vendor's computing device where the offer information includes a vendor privacy setting that indicates whether the offer is private. A request is received from a consumer's computing device for available offers and a user interface containing the offer is provided to the consumer's computing device. An indication that the consumer selected the offer is received and the offer and the vendor privacy setting are stored.

A computing device has a processor that receives an indication that a consumer has redeemed an offer during a purchase. The processor retrieves privacy settings for the offer from a memory, wherein the privacy settings include a privacy setting established by a vendor who made the offer. The processor uses the privacy settings to determine whether to publish information indicating that the consumer redeemed the offer.

A storage medium has computer-executable instructions stored thereon that when executed by a processor cause the processor to perform steps. The steps include providing a user interface to a computing device that allows selection of an offer and receiving a selection of an offer from the computing device. At least one privacy setting for the offer stored in memory is retrieved. Whether to post information about the selection of the offer is then determined based on the at least one privacy setting for the offer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of elements used in embodiments described below.

FIG. 2. is a flow diagram of a method of generating offers with privacy settings.

FIG. 3 is an example of an offer set-up user interface.

FIG. 4 is a flow diagram of a method of selecting an offer and setting a privacy setting for the offer.

FIG. 5 is an example of a user interface providing offers in response to a search.

FIG. 6 is an example of a user interface providing offer details for an offer that has been set as private by a vendor.

FIG. 7 is an example of a user interface providing offer details for an offer that has been set as public by a vendor and as public by a consumer.

FIG. 8 is an example of a user interface providing offer details for an offer that has been set as public by a vendor and as private by a consumer.

FIG. 9 is a flow diagram of a method of redeeming an offer and determining whether to publish the redemption of the offer.

FIG. 10 is a block diagram of a computing environment that may be used in the various embodiments.

### DETAILED DESCRIPTION

A system is provided in which a consumer may select a limited number of offers from one or more vendors to use when purchasing items from a retailer. By default, the system will automatically publish postings to a consumer's social media sites when the consumer either selects an offer or redeems an offer. The system provides a two-tiered privacy control to override this default. In the first tier of the privacy control, vendors are able to set their offers as private such that when an offer is selected or redeemed by a consumer, the information about the offer is not automatically shared on the consumer's social media sites. If an offer is set as private by the vendor, it cannot be made public by the consumer. In the second tier of privacy protection, the consumer is able to designate offers as private such that the selection or redemption of those offers is not automatically shared on the consumer's social media sites. Thus, both the vendor and the consumer are able to control whether the selection or redemption of any one offer is automatically shared on the consumer's social media sites.

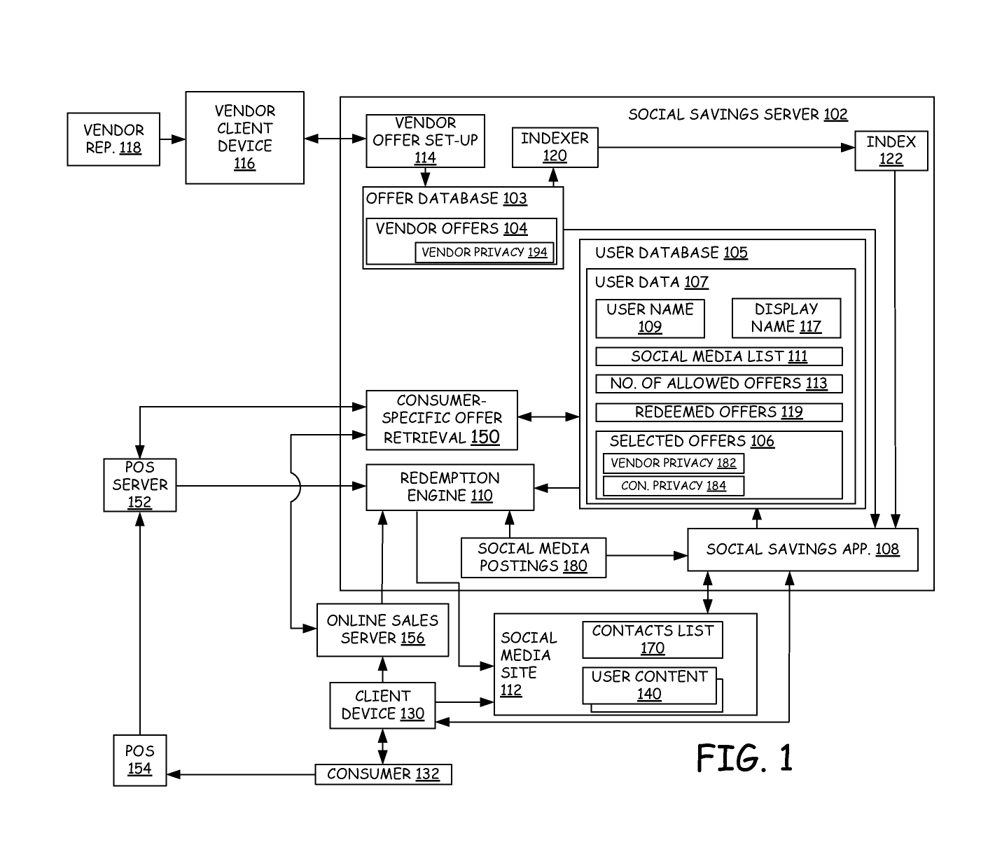

FIG. 1 provides a block diagram of elements used for establishing and utilizing privacy settings for offers. In FIG. 1, a social savings server 102 provides user interfaces to allow vendors to create and store vendor offers 104 and to set privacy settings for the offers. In addition, social savings server 102 executes a social savings application 108, which provides user interfaces allowing a consumer to select from the vendor offers 104 to form selected offers 106. The user interfaces allow consumer 132 to designate a privacy setting for any offers that have not previously been set as private by the vendor. Based on the privacy settings for selected offers 106, social savings application 108 determines whether selection of a consumer offer is published on social media sites, such as social media sites 112. Similarly, redemption engine 110 uses the privacy settings to determine whether redemption of a consumer offer should be published on social media sites, such as social media site 112.

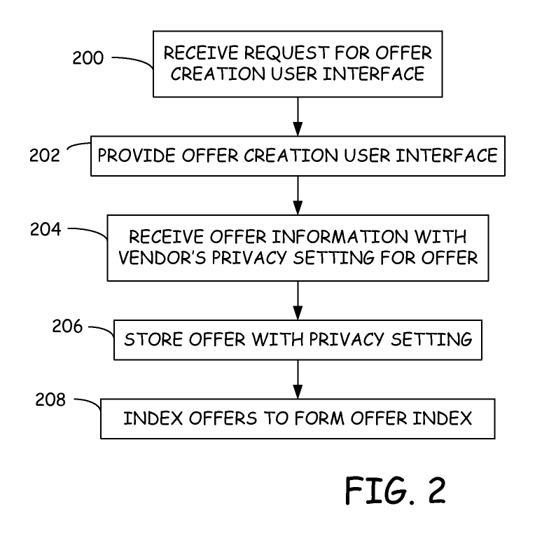

FIG. 2 provides a flow diagram for creating offers on social savings server 102. At step 200, a vendor offer set-up application 114 receives a request for an offer-creation user interface from a vendor client device 116. Vendor client device 116 is operated by a vendor representative 118 on behalf of a vendor. Vendor offer set-up application 114 may take the form of a collection of webpages having code behind that allows the webpages to execute application functions. At step 202, vendor offer set-up application 114 returns the offer-creation user interface to vendor client device 116.

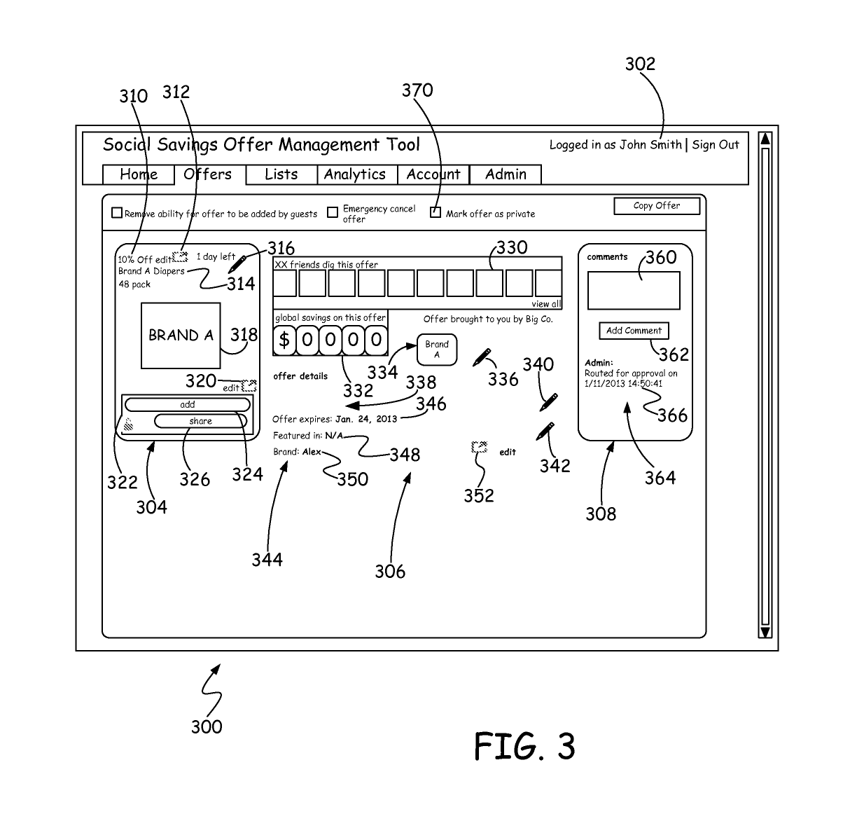

FIG. 3 provides an example of a vendor offer set-up user interface 300. In accordance with some embodiments, user interface 300 is presented to vendor representative 118 after vendor representative 118 has logged into social savings server 102 such that the identity 302 of the vendor representative and the identity of the vendor is known. Further, user interface 300 is presented after other vendor offer set-up user interfaces have been presented to vendor representative 118. These earlier set-up user interfaces allow vendor representative 118 to associate one or more product identifiers with an offer. Examples of product identifiers include a universal product code, a global trade item number, a stock keeping unit (SKU), or other retailer-specific product identifiers.

User interface 300 provides an offer card template 304, an offer details template 306 and a comments section 308. Offer card template 304 is an editable template for an offer card, which is an electronic version of a coupon that can be displayed to consumers on various client devices such as computers, laptops, tablets, personal digital assistants, readers, and phones. In particular, sets of offer cards are displayed to consumers in response to various searches such as searches for offers that were previously selected by a consumer and searches for offers involving particular types or brands of products.

Offer card template 304 includes an editable terms area 310 that describes the terms of the offer, such as 10% off, which can be set using an edit control 312. A product description area 314 describes the product connected to the offer including, for example, the size, type, model and brand of the product. Product description area 314 can be modified by activating edit icon 316. An image or video area 318 provides a display area for an image or video associated with the product. The image or video may be designated or uploaded to vendor offer set-up application 114 using edit control 320. A fixed button area 322 shows an image of an “add” button 324 and an image of a “share” button 326, that are not active in user interface 300 but are provided to show how the offer card will look when displayed to the consumer.

Offer details template 306 is an editable template of a portion of a screen that will provide details about an offer when a consumer asks to see details of an offer card. Offer details template 306 includes a social media banner 330 that provides image boxes where avatar images of social media friends who have previously selected the offer will appear. In accordance with one embodiment, the vendor is not able to modify banner 330. Offer details template 306 also includes a global savings area 332 that will indicate the total dollar amount saved worldwide by people redeeming this offer. In accordance with one embodiment, the vendor is not able to modify global savings area 332. Branding area 334 provides an area where a brand associated with the product may be identified using edit control 336. Offer details area 338 provides an area where the details of the offer may be added using edit controls 340 and 342. The details may include the name, size, type and model of the products connected to the offer and the terms of the offer such as “Buy One Get One Free” or “10% off.” Additional details area 344 provides an area where the vendor can set the expiration date 346 for the offer, printed publications where the offer was featured 348 and the brand 350 associated with the offer using edit control 352.

Comments section 308 provides a text area 360 where a vendor representative may enter comments about the offer during the creation of the offer. Such comments are only seen by the vendor and the retailer to facilitate creation of the offer and are not shared with consumers. Comments entered in text area 360 are uploaded to offer database 103 using “add comment” button 362. Previously entered comments appear in comment list 364 and, as shown for comment 366, include the username of the person who entered the comment, the date and time the comment was posted and the comment itself.

User interface 300 also includes a “mark offer as private” checkbox 370 that allows the vendor to set the offer as private. If checkbox 370 is not checked, the selection and/or redemption of the offer may be displayed via a social media site if the consumer agrees to this privacy setting. If checkbox 370 is checked, the offer is designated as private such that the selection or redemption of the offer will not be published via social media sites. Vendors may designate an offer as private for certain classes of products because they know that most consumers do not want others to know that they are buying those products. For instance, most consumers do not want other people to know that they use certain personal-hygiene products or certain medical products. If consumers are given the option to make such offers public or private, it is possible that some consumers will mistakenly choose the incorrect setting or forget to set the offer as private. This could result in an unwanted social media posting for the consumer, which in turn could result in undesirable press coverage for the vendor. To avoid any possibility of this happening, the vendor can control whether selection and redemption of the offer is posted on social media sites through privacy setting 370 and thereby limit undesirable press coverage for their product.

At step 204, after a vendor has created and submitted the offer through user interface 300, the offer information is sent from vendor client device 116 and is received by vendor offer set-up application 114. The offer information includes the information provided by the vendor through the various edit controls and whether “mark offer as private” checkbox 370 was selected. At step 206, vendor offer set-up application 114 stores the vendor offer information in vendor offers 104 together with the vendor privacy setting 194 for the offer. At step 208, an indexer 120 indexes the vendor offers 104 to produce an index 122 that is keyed by words and product names found in vendor offers 104. For each term/product name, index 122 provides a list of offers that contain that term or product name. In particular, indexer 120 indexes the words found in offer details area 338, additional details area 344, terms area 310 and description area 314.

Social savings application 108 is an offer searching application, an offer selection application and an offer sharing application. Since social savings application 108 can be realized as a collection of web pages with code behind to allow it to perform various functions, social savings application 108 is also an offer searching site, and offer selection site and an offer sharing site. Index 122 may be searched using a search user interface provided by social savings application 108. In particular, social savings application 108 provides a search user interface to client device 130 that provides a text box where a consumer 132 may enter terms and product names to be searched. When consumer 132 submits a search query, social savings application 108 searches index 122 and retrieves all offers that match the search query. Social savings application 108 then returns the matching offers to client device 130 in a search results user interface.

Consumer 132 is able to select one or more of the offers in the search results user interface. When an offer is selected by consumer 132, social savings application 108 adds the offer to a user database 105, which is stored in a memory of social savings server 102. User database 105 holds information about consumers who are registered users of social savings application 108. In particular, for each user of social savings application 108, user database 105 contains a user data record 107 that includes a username 109 that uniquely identifies the consumer on social savings application 108; a display name 117 to be displayed on user interfaces generated by social savings application 108; a social media list 111 that contains a list of social media sites associated with the consumer; selected offers 106, which is a set of offers, also referred to as a group of discounts, selected by the consumer for later redemption; number of allowed offers 113 representing the maximum number of offers allowed in selected offers 106 at any one time; and redeemed offers 119, which represents a set of offers that have been redeemed by the consumer in the past. When consumer 132 selects an offer, social savings application 108 adds the offer to selected offers 106 in the consumer's user data 107 of user database 105.

As noted in the description of database 105, the selection of an offer is different from the redemption of an offer. When an offer is selected, it is designated as being available to the consumer for later redemption. When an offer is redeemed, the discount provided by the offer is applied to the consumer's purchase to reduce the amount paid by the consumer. Once an offer is redeemed, it is removed from selected offers 106 and is added to redeemed offers 119.

Number of allowed offers 113 can be a constant number that is the same for all users of social savings application 108 or can be dynamic and user-specific such that it increases with certain actions of the user. For example, if the user invites social media contacts to join social savings application 108, the number of allowed offers 113 can be increased. In accordance with one embodiment, the number of allowed offers 113 is initially set to ten.

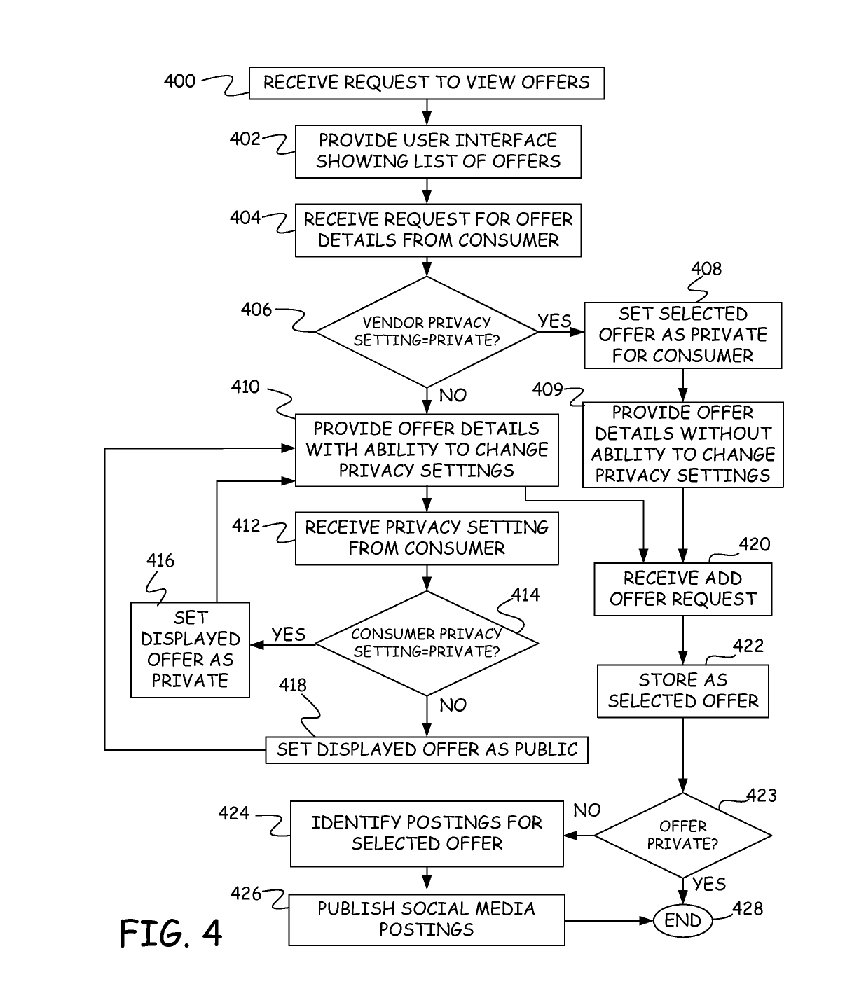

FIG. 4 provides a flow diagram of a method of selecting offers and setting a consumer privacy setting for the offer. At step 400, a social savings application 108 in social savings server 102 receives a request to view available offers from a client device 130 being operated by consumer 132. Such a request can be made by visiting a website provided by social savings application 108 or by submitting a search request to social savings application 108. In accordance with some embodiments, social savings application 108 is constructed of a collection of webpages with code behind that accepts input from the consumer and responds to that input by providing additional webpages and/or by storing or altering data on social savings server 102. At step 402, social savings application 108 provides a user interface showing a list of vendor-provided offers available to consumer 132. This user interface is displayed on the display on client device 130.

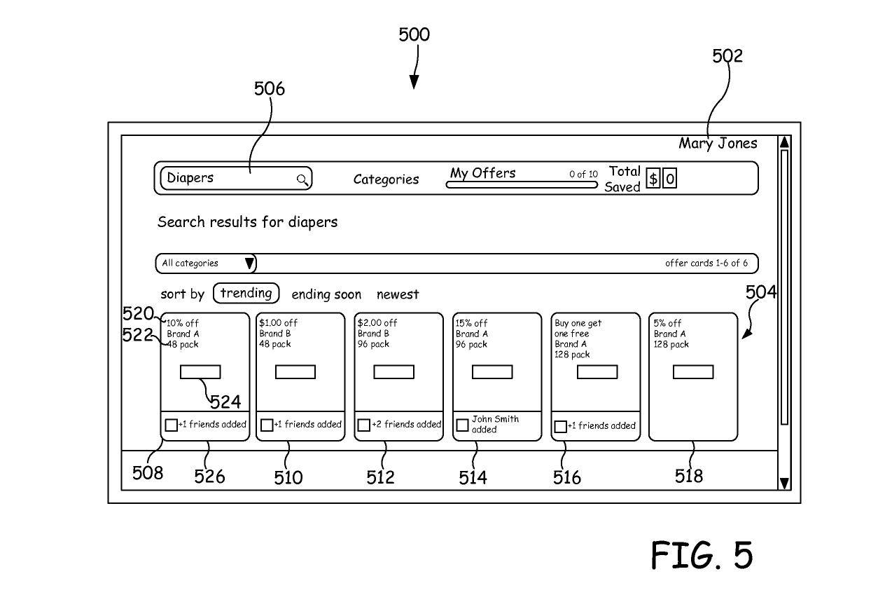

FIG. 5 provides an example of a user interface 500 showing a list of offers that consumer 132 may select from. In user interface 500, a user name 502 is displayed that corresponds to display name 117 of consumer 132. A list 504 of search results is provided in response to a search 506 for diapers. The list 504 of search results includes offer cards 508, 510, 512, 514, 516 and 518. Each of the offer cards, such as offer card 508, includes terms area 520 that describes the terms of the offer, such as 10% off, a product description area 522 that describes the product connected to the offer including, for example, the size, type, model and brand of the product and an image or video area 524 that provides a display area for an image or video associated with the product. The offer cards also include a social savings area 526 that indicates the number of “friends” of consumer 132 who have previously selected the offer. A “friend” of consumer 132 is, for example, a person listed as a “friend” or “follower” of the consumer on a social media site or any person that the consumer is “following.” In general, any person that receives content concerning consumer 132 through a social media site or any person that consumer 132 receives content about through a social media site may be considered one of consumer 132's contacts (friends) on the social media site. Social media site contacts (friends) associated with consumer 132 may also include site visitors that have been granted access to user content, such as user content 140, associated with consumer 132. Such access is often granted by consumer 132 through a user interface provided by the social media site. The content provided by the social media site can include text, images, and video, for example.

To view details about an offer, consumer 132 clicks or taps on the offer card for the offer. At step 404, social savings application 108 receives the request to view the details of the offer from client device 130. At step 406, social savings application 108 retrieves the vendor privacy settings for the offer and determines if the vendor has set this offer to be private. If the offer has been set as private by the vendor, it is determined that the consumer should not be enabled to set the consumer privacy setting for the offer. Instead, the consumer privacy setting for the offer is automatically set to private at step 408 and a user interface containing the details of the offer are returned to client device 130 at step 409. In the user interface returned at step 409, the consumer is not enabled to set a consumer privacy setting for the offer because the vendor privacy setting indicates that the offer is private.

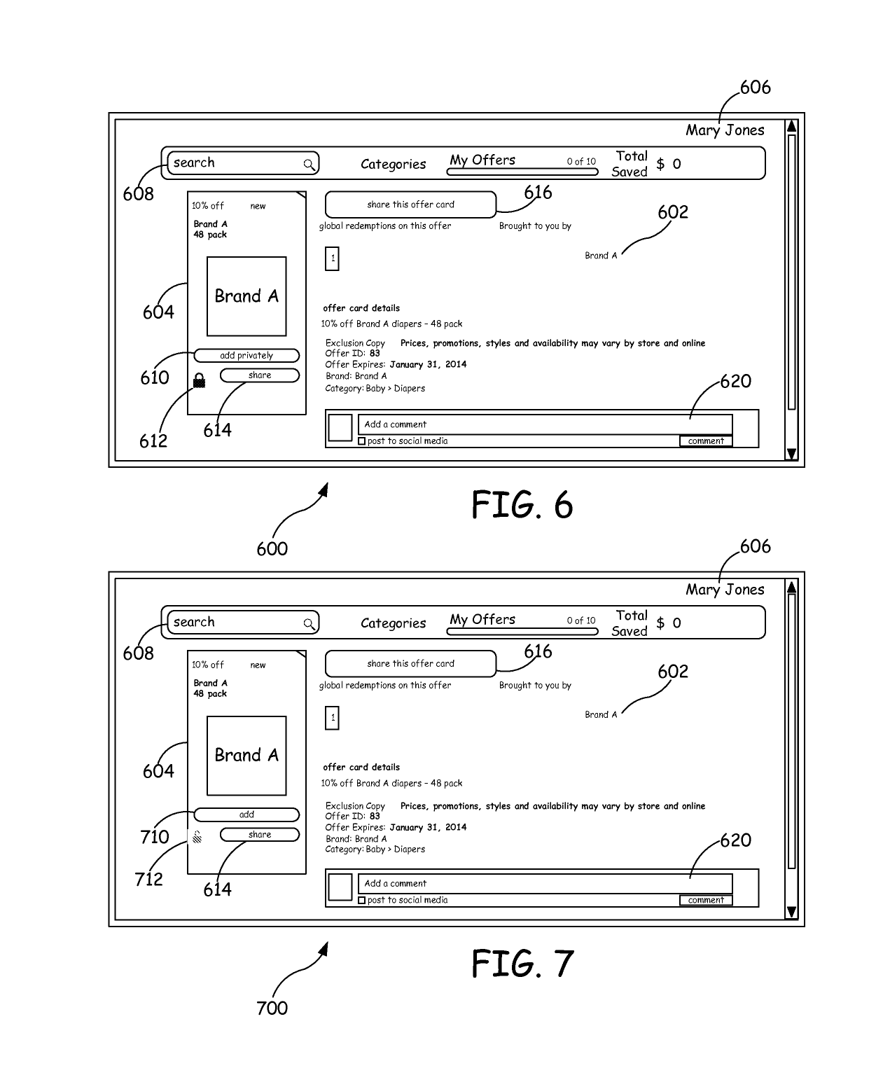

FIG. 6 provides an example of a user interface 600 containing details of an offer that are returned at step 409. User interface 600 includes offer details 602, offer card 604, user ID 606 and search box 608. Offer card 604 includes an “add privately” button 610 and a privacy icon 612. In accordance with one embodiment, privacy icon 612 takes the form of a locked padlock. Privacy icon 612 is not selectable in user interface 600 and the offer cannot be converted from a private offer to a public offer. User interface 600 also includes a “share” button 614 and a “share this offer card” button 616. If either button 614 or button 616 is selected, social savings application 108 transmits a plugin from social media site 112 to client device 130 that allows consumer 132 to share a description of the offer with some or all of the people in their contacts list 170. Note that when consumer 132 shares the description of the offer, there is no indication that consumer 132 has selected or redeemed the offer because the offer has been marked as private by the vendor. Instead, consumer 132 is only able to share a description of the offer itself. User interface 600 also includes a social media comment box 620 that allows consumer 132 to create and share a comment about the offer with people on contacts list 170 through social media site 112.

Returning to step 406 of FIG. 4, if the vendor did not set the offer as private, it is determined that the consumer should be enabled to set the consumer privacy setting for the offer. As a result, a user interface 700 (FIG. 7) is provided by social savings application 108 to client device 130 at step 410. User interface 700 includes details about the offer and enables the consumer to set the consumer privacy setting for the offer. In particular, user interface 700 includes the same elements as user interface 600 except that “add privately” button 610 has been replaced by “add” button 710 and privacy icon 612 has been replaced with selectable privacy icon 712. In accordance with one embodiment, selectable privacy icon 712 is an image of an open lock indicating that the offer is not private. Consumer 132 may click or tap on selectable privacy icon 712 to change the privacy setting for the offer.

At step 412, if consumer 132 clicks or taps on selectable privacy icon 712, client device 130 converts the click or tap into a privacy setting that it sends to social savings application 108. In particular, since selectable privacy icon 712 indicates that the offer is currently not private, when consumer 132 clicks or taps on selectable privacy icon 712, client device 130 interprets that action as a request to toggle the privacy setting of the offer to “private.” As such, client device 130 sends a consumer privacy setting of “private” to social savings application 108.

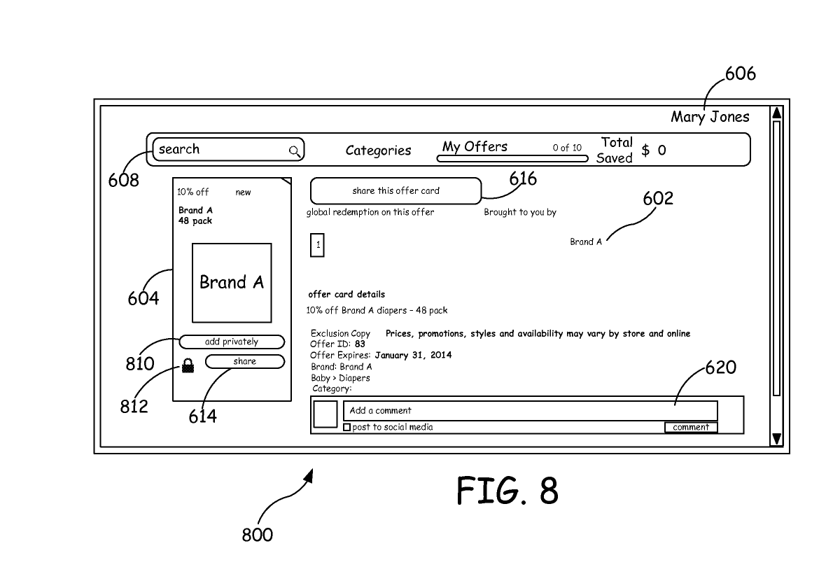

At step 414, social savings application 108 determines if the consumer privacy setting it received is “private” or “public.” If the consumer privacy setting is “private”, social savings application 108 sets the displayed offer as private at step 416 and returns to step 410. At step 410, social savings application 108 provides a user interface 800 (FIG. 8) to client device 130 that indicates that the offer is set as private and that allows consumer 132 to alter the consumer privacy setting. User interface 800 includes the same elements as user interface 700 except that “add” button 710 has been replaced by “add privately” button 810 and selectable privacy icon 712 has been replaced by selectable privacy icon 812. In accordance with one embodiment, selectable privacy icon 812 is an image of a locked lock indicating that the offer is private. Consumer 132 may click or tap on selectable privacy icon 812 to change the privacy setting for the offer back to public.

At step 412, if consumer 132 clicks or taps on selectable privacy icon 812, client device 130 converts the click or tap into a privacy setting that it sends to social savings application 108. In particular, since selectable privacy icon 812 indicates that the offer is currently private, when consumer 132 clicks or taps on selectable privacy icon 812, client device 130 interprets that action as a request to toggle the privacy setting of the offer to “public.” As such, client device 130 sends a consumer privacy setting of “public” to social savings application 108.

At step 414, social savings application 108 once again determines if the consumer privacy setting it received is “private” or “public.” If the consumer privacy setting is “public”, social savings application 108 sets the displayed offer as public at step 418 and at step 410 provides user interface 700 to client device 130 to indicate that the offer is set as public.

If consumer 132 selects “add privately” button 610 from user interface 600, “add” button 710 from user interface 700, or “add privately” button 810 from user interface 800, the process continues at step 420 where client device 130 converts the selection into an “add offer” request or offer selection that is forward to and received by social savings application 108. At step 422, social savings application 108 stores the offer as one of selected offers 106 for consumer 132 in user data 107 of user database 105. As part of storing the offer, social savings application 108 stores a vendor privacy value 182 and a consumer privacy value 184 based on the privacy settings selected by vendor representative 118 and consumer 132, respectively.

At step 423, social savings application 108 determines whether to publish a social media posting in response to the consumer selecting the offer based on vendor privacy setting 182 and consumer privacy setting 184 for the offer. In particular, social savings application 108 examines vendor privacy setting 182 and consumer privacy setting 184 stored in memory to determine whether the offer has been set to private by either vendor representative 118 or consumer 132.

If the offer has not been set as private by either vendor representative 118 or consumer 132, social savings application 108 identifies social media posting messages for the selected offer at step 424. To do this, social savings application 108 first identifies all social media sites in social media list 111 that have been associated with consumer 132 in user data 107 of user database 105. For each social media site, social savings application 108 retrieves a social media posting from social media postings 180. In accordance with one embodiment, social media postings 180 take the form of templates with fields that are filled with information taken from the selected offer. In accordance with further embodiments, a separate template is provided for each social media site in social media list 111 such that different messages can be posted to different social media sites. Such posting messages can be simple messages such as “Mary has selected an offer for 15% off a brand “A”, 96 pack of diapers.”

At step 426, social savings application 108 publishes a respective social media posting to each of the social media sites in social media list 111. For example, social savings application 108 can publish a social media posting on user content 140 of social media site 112. The social media sites then distribute the posted messages to one or more people in the contact lists of the social media sites according to the rules of distribution set in each social media site. The process then ends at step 428.

If social savings application 108 determines that the offer was set as private by either vendor representative 118 or consumer 132 at step 423, social savings application 108 does not post a message indicating that the offer was selected by consumer 132. Instead, the process of FIG. 4 ends at step 428.

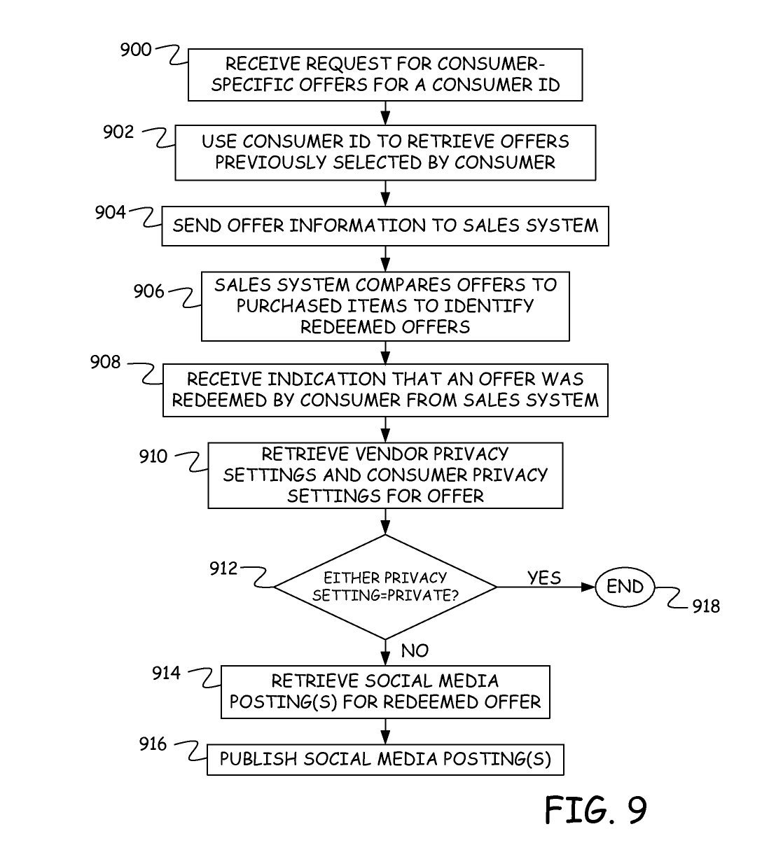

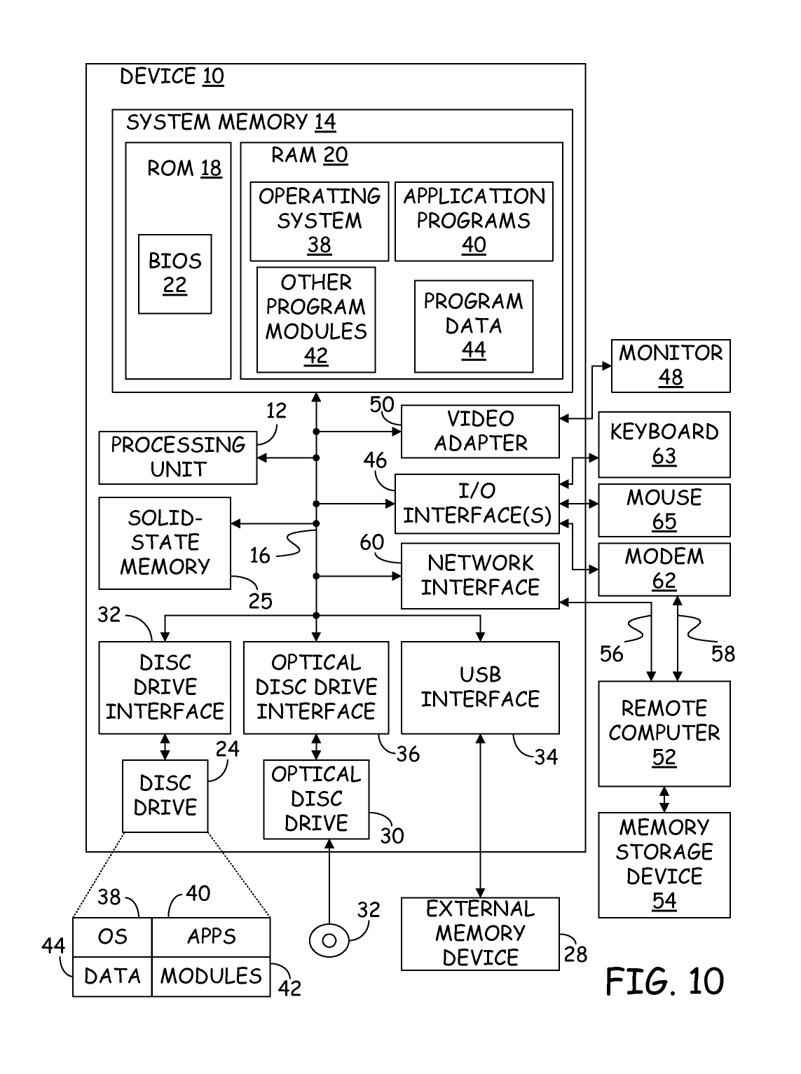

FIG. 9 provides a flow diagram of a method of determining whether to publish social media postings when a user redeems an offer. At step 900, a request for consumer-specific offers for a consumer ID is received by a consumer-specific offer retrieval application 150 on social savings server 102. Such a request may come from a point-of-sale server 152 in response to an interaction between consumer 132 and a point-of-sale register 154. In particular, consumer 132 can provide some form of identification such as a credit card or a savings card to point-of-sale register 154 by for example sliding a magnetic strip on the card through a magnetic reader and in response, point-of-sale register 154 may provide the corresponding consumer ID to point-of-sale server 152, which then uses the consumer ID to request the consumer specific offers that have been selected by the consumer associated with the consumer ID. Consumer 132 may “swipe” their card in the magnetic reader before, during or after items being purchased have been scanned by point-of-sale register 154. In other embodiments, consumer 132 may provide their consumer ID using other techniques such as using a radio frequency signal provided by a radio frequency transmitter held by consumer 132, providing a Bluetooth® signal through a mobile device or providing a signal over a wireless network through a mobile device.

A request for consumer-specific offers may also be made by an online sales server 156 in response to a sales transaction between online sales server 156 and a client device 130 operated by consumer 132. Although client device 130 is shown as the same client device used to select offers, those skilled in the art will recognize that consumer 132 may use different client devices for selecting offers than for performing sales transactions with online sales server 156. For example, consumer 132 may use a handheld client device 130 such as their mobile phone for selecting offers and may use a second client device 130 such as a laptop computer or tablet computer to perform sales transactions with online sales server 156.

Online sales server 156 receives the consumer ID from client device 130 by either requiring the consumer to login to online sales server 156 using the same consumer ID as was used when the consumer selected the offers or by requesting the consumer ID from client device 130. Client device 130 may retrieve the consumer ID from a storage location on client device 130 or may request the consumer ID from consumer 132.

The consumer ID provided to consumer-specific offer retrieval application 150 may be different from identifying information provided by consumer 132. In such cases, point-of-sale register 154 or point-of-sale server 152 may convert an identifier provided by consumer 132 into the consumer ID using one or more mapping tables. Similarly, client device 130 or online sales server 156 may convert an identifier provided by consumer 132 into the consumer ID using one or more mapping tables.

At step 902, consumer-specific offer retrieval application 150 retrieves offers previously selected by the consumer from consumer offers 106. At step 904, consumer-specific offer retrieval application 150 returns offer information for offers previously selected by the consumer to the sales system that requested the offers such as the sales system consisting of point-of-sale server 152 and point-of-sale register 154 or the sales system consisting of online sales server 156 and client device 130.

At step 906, the sales system compares the returned offers to purchased items to identify redeemed offers. For example, point-of-sale register 154 and point-of-sale server 152 determine what items are being purchased by consumer 132 and compare those items to the offers returned by consumer-specific offer retrieval application 150. If items being purchased match items associated with one or more offers, each of the matching offers is designated as a redeemed offer. Similarly, online sales server 156 identifies items that are being purchased in a transaction and compares those items to offers returned by consumer-specific offers retrieval application 150. Offers that match items being purchased are then designated as redeemed offers. In order for the sales system to identify offers that are being redeemed, the offer information provided by consumer-specific offer retrieval application 150 should identify the items associated with each offer by providing an identifier, such as the universal product code, the global trade item number, the stock keeping unit (SKU) of the product, or other retailer-specific identifier for the product.

At step 908, redemption engine 110 of social savings server 102 receives an indication that one or more offers were redeemed by the consumer from the sales system. For example, redemption engine 110 can receive an indication of which offers were redeemed from point-of-sale server 152 or online sales server 156. At step 910, redemption engine 110 retrieves vendor privacy settings 182 and consumer privacy settings 184 for the redeemed offers from selected offers 106, which are stored in memory. At step 912, redemption engine 110 determines whether to publish social media postings (referred to broadly as information) indicating that the consumer redeemed the offer based on whether either privacy setting for the offer has been set to private. If either vendor privacy setting 182 or consumer privacy setting 184 is set to private, the process ends at step 918 with redemption engine 110 determining that it will not publish a social media posting in response to the consumer redeeming the offer. If the vendor privacy setting and the consumer privacy setting are both public at step 912, redemption engine 110 determines that it will publish a social media posting in response to the consumer redeeming the offer.

To publish such a posting, redemption engine 110 first retrieves social media postings 180 for each of the redeemed offers at step 914. To do this, redemption engine 110 first identifies all social media sites in social media list 111 that have been associated with consumer 132 in user data 107 of user database 105. For each social media site, social savings application 108 retrieves a social media posting from social media postings 180. In accordance with one embodiment, social media postings 180 take the form of templates with fields that are filled with information taken from the selected offer. In accordance with further embodiments, a separate template is provided for each social media site in social media list 111 such that different messages can be posted to different social media sites. A social media posting for a redeemed offer can comprise an identification of the redeemed offer and the consumer who redeemed the offer as well as the date and time the offer was redeemed. For example, a social media posting for a redeemed offer may be “Alice just saved 15% on brand A diapers”.

At step 916, redemption engine 110 publishes the social media posting for the redeemed offer on each social media site by for example publishing the social media posting to the consumer's user content 140 on social media site 112. Each social media site then republish the social media posting to one or more of the consumer's friends or followers in accordance with settings for the consumer's user content.

Using the two-tiered privacy settings approach discussed above, both the vendor and the consumer can individually determine whether the selection and redemption of an offer will appear in a consumer's social media content. As such, the vendor has some control over whether offers selected and redeemed by the consumer appear in social media content and the consumer also has control over whether offers they select or redeem appear in social media content.

An example of a computing device that can be used as a server and/or client device in the various embodiments is shown in the block diagram of FIG. 10. The computing device 10 of FIG. 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, a solid state memory 25, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid state memory and external memory devices and their associated computer-readable media provide nonvolatile storage media for computing device 10 on which computer-executable instructions and computer-readable data structures may be stored. Other types of media that are readable by a computer may also be used in the exemplary operation environment.

A number of program modules may be stored in the drives, solid state memory 25 and RAM 20, including an operating system 38, one or more application programs 40, other program modules 42 and program data 44. For example, application programs 40 can include instructions for social savings application 108, consumer-specific offer retrieval application 150, redemption engine 110, vendor offer set-up 114, and social media site 112. Program data 44 can include vendor offers 104, index 122, user data 107, selected offers 106, vendor privacy settings 182, consumer privacy settings 184, social media postings 180, contacts list 170 and user content 140.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

Computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 10. The network connections depicted in FIG. 10 include a local area network (LAN) 56 and a wide area network (WAN) 58. Such network environments are commonplace in the art.

Computing device 10 is connected to the LAN 56 through a network interface 60. Computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 10 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
providing a user interface to a vendor's computing device that requests offer information for an offer provided by the vendor;
receiving the offer information from the vendor's computing device, the offer information comprising a vendor privacy setting that indicates whether the offer is private;
receiving a request from a consumer's computing device for available offers;
providing to the consumer's computing device a user interface comprising the offer provided by the vendor;
receiving from the consumer's computing device an indication that the consumer selected the offer provided by the vendor; and
storing the offer and the vendor privacy setting for the offer for the consumer.

2. The method of claim 1 further comprising determining whether to publish a social media posting in response to the consumer selecting the offer based at least in part on the vendor privacy setting for the offer.

3. The method of claim 1 further comprising receiving an indication that the consumer has redeemed the offer and determining not to publish a social media posting in response to the consumer redeeming the offer if the vendor privacy setting indicates that the offer is private.

4. The method of claim 1 further comprising determining whether to enable a consumer to set a consumer privacy setting for the offer based on the vendor privacy setting.

5. The method of claim 4 wherein determining whether to enable a consumer to set a consumer privacy setting for the offer comprises determining that a consumer should not be enabled to set a consumer privacy setting for the offer because the vendor privacy setting indicates that the offer is private.

6. The method of claim 5 wherein determining whether to enable a consumer to set a consumer privacy setting for the offer comprises determining that a consumer should be enabled to set a consumer privacy setting for the offer because the vendor privacy setting indicates that the offer is not private.

7. The method of claim 6 further comprising providing a user interface to the consumer's computing device that enables the consumer to set the consumer privacy setting for the offer, receiving the consumer privacy setting for the offer and storing the consumer privacy setting for the offer.

8. The method of claim 7 further comprising determining whether to publish a social media posting in response to the consumer selecting the offer based on the vendor privacy setting and the consumer privacy setting for the offer.

9. The method of claim 8 further comprising publishing a social media posting in response to the consumer selecting the offer if it is determined that the vendor privacy setting indicates that the offer is not private and the consumer privacy setting indicates that the offer is not private.

10. The method of claim 7 further comprising receiving an indication that the consumer has redeemed the offer and determining not to publish a social media posting in response to the consumer redeeming the offer if the consumer privacy setting indicates that the offer is private.

11. A computing device comprising:
a processor receiving an indication that a consumer has redeemed an offer during a purchase;
the processor retrieving privacy settings for the offer from a memory, wherein the privacy settings comprise a privacy setting established by a vendor who made the offer; and
the processor using the privacy settings to determine whether to publish information indicating that the consumer redeemed the offer.

12. The computing device of claim 11 wherein the privacy setting established by the vendor sets the offer as private such that the processor determines that information indicating that the consumer redeemed the offer should not be published.

13. The computing device of claim 11 wherein the privacy settings further comprise a privacy setting set by the consumer before the consumer redeemed the offer.

14. The computing device of claim 13 wherein the privacy setting established by the vendor sets the offer as not private and the privacy setting set by the consumer sets the offer as private such that the processor determines that information indicating that the consumer redeemed the offer should not be published.

15. The computing device of claim 13 wherein the privacy setting established by the vendor sets the offer as not private and the privacy setting set by the consumer sets the offer as not private such that the processor determines that information indicating that the consumer redeemed the offer should be published and the processor further publishes the information indicating that the consumer redeemed the offer.

16. The computing device of claim 15 wherein the processor publishes the information indicating that the consumer redeemed the offer on at least one social media site.

17. A storage medium having computer-executable instructions stored thereon that when executed by a processor cause the processor to perform steps comprising:
providing a user interface to a computing device that allows selection of an offer;
receiving a selection of an offer from the computing device;
accessing at least one privacy setting for the offer stored in memory; and
determining whether to post information about the selection of the offer based on the at least one privacy setting for the offer.

18. The storage medium of claim 17 wherein accessing at least one privacy setting comprises accessing a privacy setting established by a vendor who made the offer.

19. The storage medium of claim 18 wherein accessing at least one privacy setting further comprises accessing a privacy setting established by a consumer who selected the offer.

20. The storage medium 17 further comprising receiving an indication that an offer has been redeemed, accessing the at least one privacy setting for the offer stored in memory, and determining whether to post information about the redemption of the offer based on the at least one privacy setting for the offer.
